(19) United States
(12) Patent Application Publication
(10) Pub. No.: US 2006/0253326 A1
(43) Pub. Date: Nov. 9, 2006

(54) System and method for direct communication between consumers and vendors

(76) Inventors: Jack C. Patterson, Santa Monica, CA (US); Michael D. Patterson, Santa Monica, CA (US)

Correspondence Address: MARC E. HANKIN, ESQ., 11414 THURSTON CIRCLE, LOS ANGELES, CA, 90049, US

(21) Appl. No.: 11/416,118

(22) Filed: May 2, 2006

Related U.S. Application Data
(60) Provisional application No. 60/679,037, filed on May 8, 2005.

(51) Int. Cl. G06Q 30/00

(52) U.S. Cl. 705/14

(57) ABSTRACT

This invention discloses a communication device for use with computers and networks. Users are allowed to select certain preferred vendors from whom the user would like to receive information, advertisements, and/or promotions and/or with whom the user would like to communicate, and/or otherwise directly interact.

### RELATED APPLICATIONS

This application claims the benefit of U.S. Provisional Application No. 60/679,037, filed on May 8, 2005.

### FIELD OF INVENTION

This invention relates, generally, to a system and method for communication; more particularly to a system and method for communication that allows direct communication and solicitation from vendors to consumers using a software based communication device.

### BACKGROUND

In recent years, computers and the world wide web have enabled vendors and publishers to develop novel means for sales, advertising, and communications. Vendors have developed internet based markets that allow sales without the need to provide traditional brick and mortar stores, saving both vendors and consumers time and money. Along with these commercial developments, advertisers also have exploited the internet as a novel means of contacting and attracting potential consumers.

Three of the current, commonplace systems for attracting internet based customers are banner ads, targeted email advertising, and search advertising. In banner advertising, a vendor places advertisements and other information on a website in order to attract customers. The customer may then click on the vendor's advertisement in order to be transferred to a different website with more information about the vendor's products and/or services. One of the disadvantages of banner advertising, however, is that the vendor is not able to target past customers or customers who are known to have an interest in the vendor's products and/or services. Also, because the vendor relies upon an advertisement placed on a third-party's website, the vendor is unable to directly contact its customers.

Targeted email advertising allows vendors to overcome some of these shortcomings by allowing vendors to target past or known customers. Also, the contact between the vendor and the customers is direct because the vendor does not rely upon a third-party to place the vendor's advertisement. However, email advertisements are often ignored and deleted by consumers without being reviewed.

Search advertising is similarly limited because, while a vendor is able to target consumers looking for the vendor's products or services, the vendor is unable to maintain contact with interested consumers on an ongoing basis. Further, the vendor is unable to develop a list of potential clients to whom the vendor may solicit special offers or advertising.

Further shortcomings of the current, commonplace internet-based advertising systems are that vendors face challenges in identifying their pool of customers, keeping customers posted about new products and offers, and maintaining long-term contact with regular customers. Also, vendors are unable to access a system that facilitates both marketing and communications with valued customers.

Recent developments in the area of instant messaging have further improved communications between vendors and customers. Customers may, for example, conduct a dialogue with vendors' service representatives through instant messaging applications that are placed on vendors' websites. Instant messaging, however, does not address many of the advertising issues discussed above. Also, instant messaging usually requires the additional steps of a consumer entering a vendor's website in order to initiate the communication process.

Thus, there remains a long-felt need in the art for a direct communications means between customers and vendors that allows advertising and communications with interested customers while avoiding the shortcomings discussed above.

### SUMMARY OF THE INVENTION

This invention is directed towards overcoming the above shortcomings by disclosing a novel software-based communication and advertising system that facilitates direct communication between vendors and consumers.

In one embodiment, the invention is comprised of a software program that is loaded by consumers onto their personal computers, mobile devices, or similar such items. The software may be downloaded from one or more websites by the consumer or may be provided on a compact disc, DVD, flash drive, or similar media for installation on the customer's computer. The software serves as the customer's interface with the system by allowing the customer's computer to exchange data with a central server that facilitates direct communication between customers and vendors.

In one embodiment of the invention, the customer enters to the software program data about those vendors from whom the customer is interested in receiving further information or may be interested in making future purchases through their web sites. This information can be entered by typing the vendor's name, website, nickname, or other information into a data field. Alternatively, the vendor's information may be selected from a pull-down menu, a directory, searched for by the customer, or accessed by any of the other means commonly practiced in the art. In one embodiment of the invention, in visiting a vendor's website, the consumer may click on a link that will serve to connect the software program to that vendor for future advertising, communications, and promotions.

In one embodiment, the information is then transferred to the central server for processing and to register the customer to the database of a given vendor. In another embodiment of the invention, the information on a customer's preferred vendors is stored in the customer's personal computer. In yet another embodiment of the invention, the information is stored on both the central server and the customer's personal computer. In yet another embodiment, the customer's information is provided to the vendor for the vendor's future use.

In this manner, the customer can assemble a list of preferred vendors, which is stored in one of the above locations. This information is later used by the vendors and the central server to update, advertise to, communicate with, and otherwise contact the consumer directly.

In one embodiment of the invention, the vendors contact the consumer directly with special offers and/or advertisements. Once the consumer is registered with a particular vendor, the vendor may direct solicitations and advertisements directly to the consumer's software application. Meanwhile, as this interchange and communication continues, the vendor develops a better understanding of individual consumer's needs. Thus, targeted advertising and solicitations may become increasingly specific over time.

In yet another embodiment of the invention, a customer is able to register with a particular vendor, after having downloaded the software application, simply by clicking on an icon on the vendor's website that initiates a registration or communication between the customer and vendor.

In yet another embodiment of the invention, consumers are able to create and distribute their own content. Thus, consumers that have downloaded the software application are able to broadcast their own content to other consumers on the system.

### BRIEF DESCRIPTION OF THE DRAWINGS

FIG. 1 is an illustration of one embodiment of the invention while in a vendor input mode.

FIG. 2 is an illustration of one embodiment of the invention while in a vendor information display mode.

FIG. 3 is a flow chart that demonstrates the method in one embodiment of the invention.

### DETAILED DESCRIPTION OF THE DRAWINGS

In the following detailed description of various embodiments of the invention, numerous specific details are set forth in order to provide a thorough understanding of various aspects of one or more embodiments of the invention. However, one or more embodiments of the invention may be practiced without these specific details. In other instances, well-known methods, procedures, and/or components have not been described in detail so as not to unnecessarily obscure aspects of embodiments of the invention.

In the following description, certain terminology is used to describe certain features of one or more embodiments of the invention. For instance, “consumer” refers to any person and/or entity that accesses the invention; “computer” refers to any desktop, laptop, portable, handheld, PDA, mobile computing device, or other such computer device that allows communication over a network; “vendor” refers to any provider of any goods or services and/or publisher; and “advertisement” refers to any information conveyed from a vendor to any potential customer.

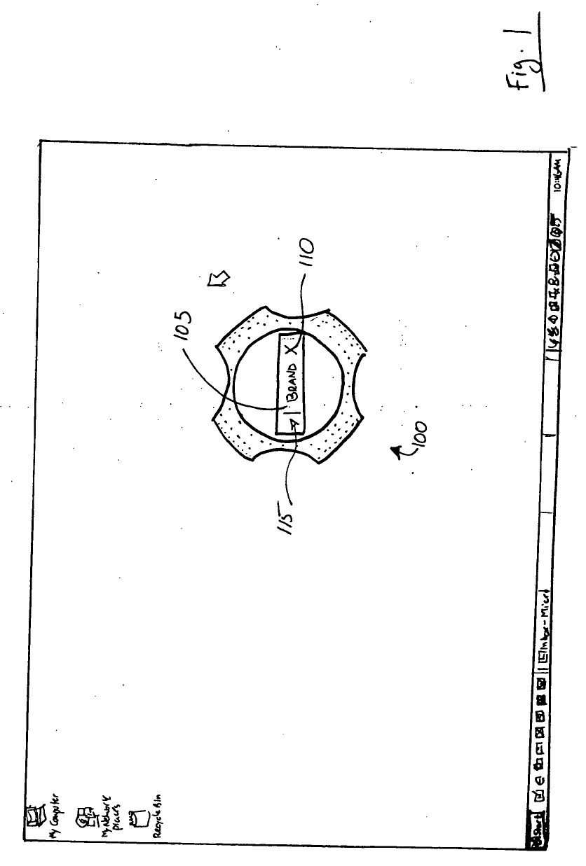

FIG. 1 is an illustration of one embodiment of the invention while in a vendor input mode. The software application 100 is shown on the user's screen. The software application 100 includes an input area 105 for the input of a vendor name 110. The input area 105 further includes a drop down menu 115, which allows the user to select vendor names from a list.

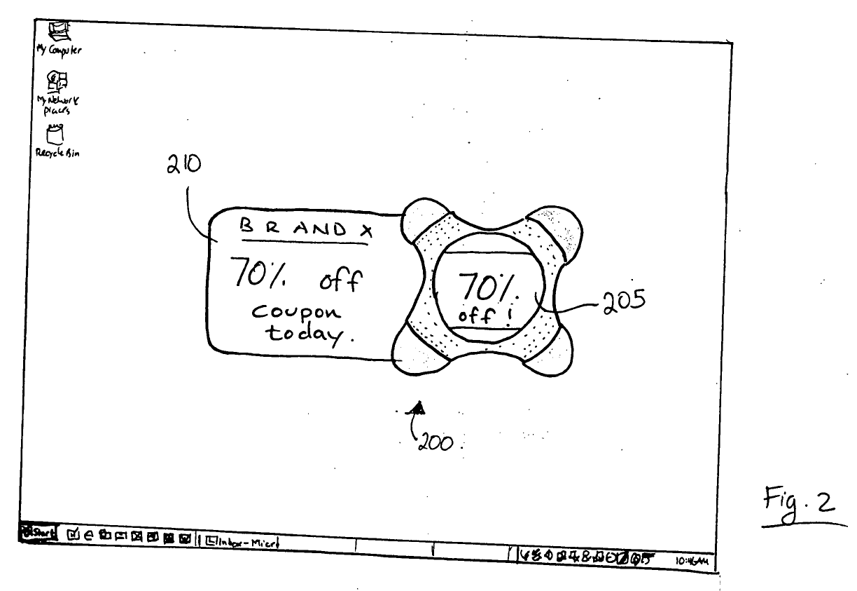

FIG. 2 is an illustration of one embodiment of the invention while in a vendor information display mode. The software application 200 is shown on the user's screen. The vendor has communicated an advertisement which is included in the center 205 of the software application 200 and a side bar advertisement 210, which allows further information to be conveyed to the user. Either of the advertisements 205 and 210 may feature hyperlinks to the vendor's website.

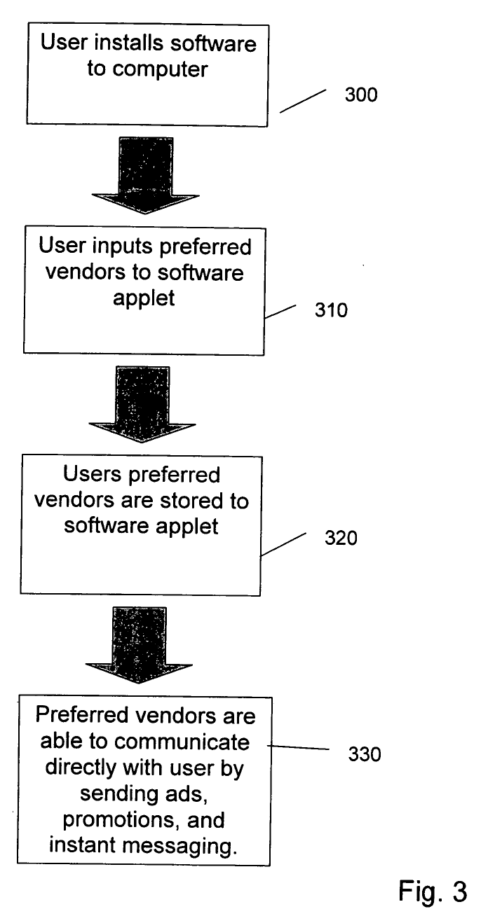

FIG. 3 is a flow chart that demonstrates the method in one embodiment of the invention. First, 300 the user installs the software application to his/her computer. Then, 310 the user inputs preferred vendors to the software application by entering names, choosing from a drop down list, or searching among vendors. Next, 320 the user's preferred vendors are stored to the software application, a central server, or the vendor's computers. Finally, 330 preferred vendors are able to communicate directly with the user by sending advertisements, promotions, and instant messages.

What is claimed is:

1. A communications system, comprising:
a software application that is installed to a user's computer,
said software application comprising a means for a user to enter a number of preferred vendors to said communications system,
said software application further comprising a means by which said vendors may communicate directly with users over a network.

2. A communications system according to claim 1, wherein said means by which said vendors may communicate directly with users comprises one or more of the following: instant messaging, posting advertisements on the users' computer, posting special offers on the users' computer, contacting the user to perform common customer service functions, and contacting the user in order to solicit marketing research information.

3. A communications system according to claim 1, wherein said means for a user to enter a number of preferred vendors to said communications system further comprises a system for searching for preferred vendors.

4. A communications system according to claim 1, wherein said means for a user to enter a number of preferred vendors to said communications system further comprises a system for selecting preferred vendors from a list.

5. A communications system according to claim 1, wherein said preferred vendors are compiled and stored in said software application.

6. A communications system according to claim 1, wherein said preferred vendors are compiled and stored in a central server with which said software application communicates.

7. A communications system according to claim 1, wherein said preferred vendors are notified of a user's interest by way of said software application.

8. A communications system according to claim 1, wherein said software application further comprises a graphical user interface (GUI), said graphical user interface comprising a means for a user to enter a number of preferred vendors to said communications system.

9. A communications system according to claim 8, wherein said means by which said vendors may communicate directly with users comprises one or more of the following: instant messaging, posting advertisements on the users' computer, posting special offers on the users' computer, contacting the user to perform common customer service functions, and contacting the user in order to solicit marketing research information.

10. A communications system according to claim 8, wherein said means for a user to enter a number of preferred vendors to said communications system further comprises a system for searching for preferred vendors.

11. A communications system according to claim 8, wherein said means for a user to enter a number of preferred vendors to said communications system further comprises a system for selecting preferred vendors from a list.

12. A communications system according to claim 8, wherein said means for a user to enter a number of preferred vendors to said communications system comprises clicking on an icon the vendors website in order to initiate a communication between the user and the vendor.

13. A communications system according to claim 8, wherein said preferred vendors are compiled and stored in said software application.

14. A communications system according to claim 8, wherein said preferred vendors are compiled and stored in a central server with which said software application communicates.

15. A communications system according to claim 8, wherein said preferred vendors are notified of a user's interest by said software application.

16. A communications system according to claim 8, wherein said software application further provides a system by which consumers may create and distribute their own content.

17. A method for communications between vendors and consumers, comprising:
the installation of a software application on a user's computer,
the input of preferred vendors into said software application by the user,
the storage of the user's list of preferred vendors, and
the communication of information by one or more of said preferred vendors to said users over a network.

18. A communications method according to claim 17, wherein said communication of information comprises one or more of the following: instant messaging, posting advertisements on the users' computer, posting special offers on the users' computer, contacting the user to perform common customer service functions, and contacting the user in order to solicit marketing research information.

19. A communications system, comprising:
a software application that is installed to a user's computer,
said software application comprising a means for a user to enter a number of preferred vendors to said communications system, said means for a user to enter a number of preferred vendors comprising one or more of the following: entering vendor names, entering vendor websites, selecting names from a menu, or searching for names,
said software application further comprising a means by which said vendors may communicate directly with users over a network through one or more of the following: instant messaging, posting advertisements on the users' computer, posting special offers on the users' computer, contacting the user to perform common customer service functions, and contacting the user in order to solicit marketing research information, and
a central information server, said central information server serving as a system to route data transmissions between users and vendors.
